(19) United States
(12) Patent Application Publication
(10) Pub. No.: US 2011/0014932 A1
(43) Pub. Date: Jan. 20, 2011

(54) Mobile Telephony Combining Voice and Ancillary Information

(75) Inventor: Leonardo William Estevez, Rowlett, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/505,159

(22) Filed: Jul. 17, 2009

(51) Int. Cl. H04W 4/00

(52) U.S. Cl. 455/466

(57) ABSTRACT

A telephone handset, such as a mobile telephone handset, capable of transmitting and receiving ancillary information such as an emotional state or the context of a telephone call, in advance of or in connection with the call. In one embodiment of the invention, the calling party selects various ancillary information such as current emotional state, an urgency level, and a purpose of the call, for transmission with the voice information in the call to the intended recipient. According to another embodiment of the invention, a calling phone or receiving phone accesses an online social networking service to retrieve current status information regarding the intended recipient or calling party, respectively. According to another embodiment of the invention, current state information from functions such as a GPS receiver, accelerometer, or calendar function on board with the telephone handset are used to generate and transmit a visual indicator of the user of the handset.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This invention is in the field of mobile telephone communications. Embodiments of this invention are more specifically directed to mobile telephone communications including the communication of information ancillary to voice communications.

In recent years, mobile telephony has become a predominant communications technology, even to the point that many consumers use their mobile (i.e., cellular) telephones exclusively, instead of traditional “land-line” home or office telephones. In addition, modern mobile telephone handsets now include a wide range of capabilities beyond mere voice telephone communications. “SMS” (Short Message Service) messaging services, communicating text or multi-media content or both, are now available even in relatively modest cell phone handsets, considering that even such modest handsets include built-in digital camera functions (both still and video). So-called “smartphones” now serve essentially as small computers, and carrying out high-level applications under modern operating systems. These smartphones are now capable of high-speed Internet access, with full web page viewing, email communications via email client applications, office document generation and editing, and multimedia playback of streaming video programming and of media stored locally on the handset. Global Positioning System (GPS) capability is now also provided by some smartphones. Many of these smartphones provide so-called “3G” capability, by way of which high-speed Internet and other data access is provided over the cellular channels, and also WiFi capability to connect to wireless local area networks, such as those operating under the IEEE 802.11x standards.

Indeed, modern cell phone operating systems such as the WINDOWS MOBILE operating system available from Microsoft Corporation, the GARNET operating system available from Palm, Inc., open source operating systems such as the SYMBIAN and LINUX operating systems, the ANDROID operating system developed by Google Inc., and proprietary operating systems such as those used by the IPHONE available from Apple Corporation and the BLACKBERRY available from Research In Motion Limited, provide a wide range of capability to modern smartphones. Some of these operating systems provide multi-tasking and multi-threading operation, enabling the smartphone to execute applications while a voice call is in progress. These operating systems and environments provide platforms from which new applications by third parties (i.e., other than the cellphone manufacturer) have become developed and available, in many cases with the encouragement of the cellphone manufacturer.

By way of further background, social networking websites and services have now become widely popular in the marketplace. Examples of popular social networking sites include the FACEBOOK, MYSPACE, TWITTER, and LINKEDIN services. A recent feature provided by these and other social networking services involves the real-time communication of current activity and emotional state by those posting on the service. For example, many user pages of these social networking sites and services include recent text entries indicating what the user is currently doing, and also an indicator of the current mood of that user. These social networking sites are not only accessible from personal computers, but access to these social networking sites from cell phone handsets has become widely popular.

By way of further background, smartphone applications that interface with social networking sites are now being developed. One example of such an application is the “Tweetabouts” application under the ANDROID operating system, which periodically updates the user's TWITTER profile with the current location of the cellphone, using either GPS or cellular tower information. Another application automatically updates a mood indicator in the user's social networking page with the most recent cell phone photo taken by the user.

### BRIEF SUMMARY OF THE INVENTION

Embodiments of this invention provide a mobile telephony system and method of operating the same in which information ancillary to a call, such as a current emotional state of one or more parties to a call, or a context or purpose of the call, accompanies the voice phone call.

Embodiments of this invention provide such a system and method in which both an emotional state and a substantive context of the call is received at the recipient's mobile telephone handset in conjunction with a call.

Embodiments of this invention thus provide additional information outside of the voice contents of a telephone call, so that one or both parties are better able to effectively and appropriately communicate in the telephone call.

Other objects and advantages provided by embodiments of this invention will be apparent to those of ordinary skill in the art having reference to the following specification together with its drawings.

The present invention may be implemented into a mobile telephone handset, such as a modern smartphone, that executes an application in conjunction with a call being placed or being received. According to one aspect of the invention, the application allows the calling party to select and configure ancillary information to be transmitted with a call being placed. The ancillary information can include information regarding a current emotional state, information regarding the context or purpose of the call, a location of the calling party, and the like. The ancillary information can be communicated over a secondary channel, or otherwise encoded within the datastream of the call. The contextual information can be displayed at the recipient's handset by way of an avatar or other visual aid.

According to another aspect of the invention, the handset of the receiving party automatically, in response to an incoming call, queries a social networking page of the calling party, to retrieve a current emotional state, location, and other contextual information as the call regarding the calling party. This contextual information is displayed by the handset, either prior to or with acceptance of the call.

According to another aspect of the invention, the handset of a party placing a call automatically queries a social networking page of the intended recipient of the call, to retrieve a current emotional state, location, and other contextual information of the recipient. This contextual information is displayed by the calling party's handset, either prior to or with acceptance of the call.

### BRIEF DESCRIPTION OF THE SEVERAL VIEWS OF THE DRAWING

FIG. 1 is an electrical diagram, in block form, of a smartphone constructed according to embodiments of this invention.

FIG. 2a is a flow chart illustrating the operation of a smartphone placing a call according to a first embodiment of this invention.

FIG. 2b illustrates displayed images on smartphones placing and receiving calls according to the first embodiment of this invention.

FIG. 2c is a schematic diagram illustrating communications carried out between telephone handsets according to this first embodiment of this invention.

FIG. 2d is a flow chart illustrating the operation of a smartphone receiving a call according to the first embodiment of this invention.

FIG. 3 is a block diagram illustrating a software environment in a smartphone constructed according to embodiments of this invention.

FIG. 4a is a flow chart illustrating the operation of a smartphone receiving a call according to a second embodiment of this invention.

FIG. 4b is a schematic diagram illustrating communications carried out between telephone handsets according to this second embodiment of this invention.

FIG. 5a is a flow chart illustrating the operation of a smartphone placing a call according to a third embodiment of this invention.

FIG. 5b is a schematic diagram illustrating communications carried out between telephone handsets according to this third embodiment of this invention.

FIG. 6 is a flow chart illustrating the operation of a smartphone generating visual ancillary information according to a fourth embodiment of this invention.

### DETAILED DESCRIPTION OF THE INVENTION

The present invention will be described in connection with its embodiments, for example as implemented into a mobile telephone handset, because it is contemplated that this invention will be especially beneficial when used in such an application. However, it is contemplated that the benefits of this invention may be attained, at least in part, by implementation of the inventive concepts in connection with other communications systems and methods of operating the same. For example, it is contemplated that embodiments of this invention may be implemented in and operated by land-line telephones having sufficient communication and computational capability, or by computers and workstations that are operating as telephones, particularly where such land-line communications are carried out over a Voice over Internet Protocol (VoIP) link or service. Accordingly, it is to be understood that the following description is provided by way of example only, and is not intended to limit the true scope of this invention as claimed.

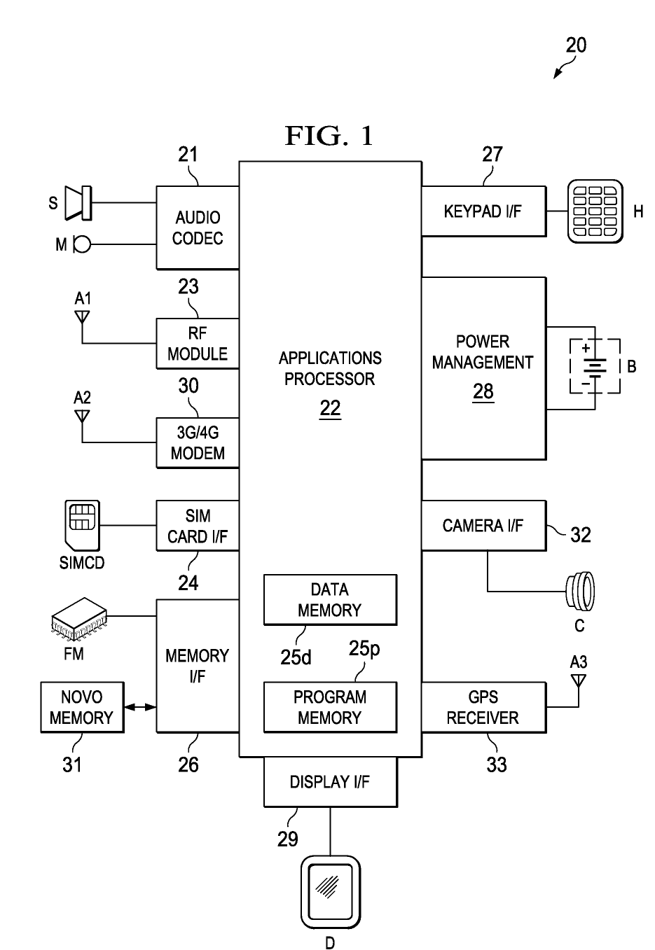

Referring now to FIG. 1, the construction of an electronic system according to an embodiment of this invention will now be described, by way of an example of a mobile telephone handset 20 of a type commonly referred to as a “smartphone”. Typically, the term “smartphone” refers, in the art, to a mobile phone that provides computer-like or other advanced functionality beyond a mobile telephone. For example, typical smartphones execute operating systems similar to that executed by desktop and laptop computers, such operating systems providing a “platform” that supports application programs that can be developed and added after purchase of the device. In contrast to the captive or native applications that are provided with basic mobile telephones, many smartphone applications are developed by parties other than the smartphone manufacturer, and acquired and installed by the user. Typical smartphone application programs include email clients, web browser applications, “e-book” reader applications, applications for generating and editing office documents, and the like. For purposes of this specification, it is contemplated that the term “smartphone”, as referring to smartphone 20 of FIG. 1 by way of example, is to be interpreted to include such mobile telephone handsets that provide the computational capability for executing application programs, including those functions described herein, and is not intended to be interpreted in any limited sense. Indeed, it is contemplated that, in the near future, little distinction will remain between “basic” mobile telephone handsets and so-called “smartphones”, as it is believed that virtually every mobile telephone handset with the capability of performing the functions described in this specification in connection with this embodiment of the invention will be a “smartphone”. This belief is evident from today's market, in which even the most basic of mobile telephone handsets include multimedia text messaging capability and at least a rudimentary digital camera function.

Referring to FIG. 1, the digital functionality controlling the operation of smartphone 20 is centered on applications processor 22, which is a conventional single or multiple processor core integrated circuit device, such as the OMAP4xxx applications processors available from Texas Instruments Incorporated. As known in the art, such applications processors are capable of managing mobile telephony from the client or handset side, and of implementing other functions and applications including a digital camera function, data and multimedia wireless communications, audio and video streaming, storage, and playback, and the like, and capable of carrying out these functions under an operating system with multi-processing or multi-threading capability. As such, applications processor 22 in smartphone 20 provides substantial computational power. For example, the OMAP 4 applications processors include multiple computational “engines”: a programmable multimedia engine based on the C64x digital signal processors (DSPs) available from Texas Instruments Incorporated; one or more multi-format hardware accelerators; general-purpose processor capability such as that provided by dual-core ARM CORTEX A9 MPCORE processors; a programmable graphics engine; and an Image Signal Processor (ISP) for providing video and imaging functionality. Of course, other architectures and capabilities (lesser or greater) may be provided by applications processor 22 within smartphone 20 in this embodiment of the invention.

As shown in FIG. 1, applications processor 22 includes program memory 25p, which stores computer-executable instructions and software routines that, when executed by applications processor 22, carries out the functions executed by smartphone 20 according to embodiments of this invention. It is contemplated that program memory 25p will be realized as some form of non-volatile memory such as electrically erasable programmable read-only memory (EEPROM), considering that the applications program instructions stored therein should persist after power-down of smartphone 20. It is, of course, contemplated that program memory 25p may alternatively be realized in other ways besides within applications processor 22, for example by way of a memory resource external to the integrated circuit that realizes applications processor 22, for example non-volatile memory 31 in communications with applications processor 22 via memory interface 26. Applications processor 22 also includes data memory 22d, either contained within the same integrated circuit as the processing circuitry of applications processor 22 or external thereto, for storing results of its various processing routines and functions. Data memory 22d may be realized as conventional volatile random access memory (RAM), or as non-volatile memory such as EEPROM (for example to retain address book and profile information within smartphone 20), or as some combination of the two.

FIG. 1 illustrates that applications processor 22 cooperates with various interface functions within smartphone 20. Audio codec 21 manages the acquisition of audio input from microphone M and the communication of audio signals to applications processor 22 for eventual transmission as part of telephone calls over the cellular wireless link, and also the output of audio output via speaker S based on signals from application processor 22 received over the wireless link. RF module 23 is coupled to applications processor 22 and to antenna A1, and manages the modulation digital data processed by applications processor 22 and its transmission over the cellular wireless link, as well as the receipt of wireless signals and the demodulation of those signals into data for processing by applications processor 22 and eventual storage or output. SIM card interface 24 provides a memory interface function between applications processor 22 and SIM card SIMCD, on which identification information and also user information such as phone numbers are stored, in the conventional manner. Memory interface 26 couples applications processor 22 to flash memory device FM, on which user data such as digital image files, audio files, video files, and the like may be stored, and also couples applications processor 22 to non-volatile memory 31 as mentioned above, and which will be described below. Display interface 29 provides the appropriate video interface between applications processor 22 and phone display D, on which telephone operating information, text, graphics, video, and other visual output are displayed to the user. Keypad interface 27 communicates user inputs, entered via the keypad or keyboard H, or another input peripheral device, to applications processor 22. Alternatively, keypad H and display D may be implemented in combination as a touchscreen, as known in the art.

Also in this embodiment of the invention, smartphone 20 includes modulator/demodulator (modem) 30, coupled to applications processor 22 and to antenna A2, which manages wireless data communications over a high-speed cellular link, for example according to the “3G” or “4G” mobile telephony standards known in the art. In connection with some embodiments of this invention, as will become apparent from this specification, it will be useful for applications processor 22 to be carrying out communications over both wireless links (i.e., via RF module 23 and also via modem 30) simultaneously, in a multi-processing or multi-threading manner. This example of smartphone 20 also includes Global Positioning System (GPS) receiver 33, coupled to applications processor 22 and to antenna A3, for receiving signals from orbiting satellites so that applications processor 22 can execute program instructions stored in program memory 25p or elsewhere to calculate an approximate geographical position of smartphone 20.

Also according to this embodiment of the invention, as mentioned above, memory interface 26 couples non-volatile memory 31 to applications processor 22. Non-volatile memory 31 may, for example, be realized as EEPROM solid-state memory in either a NOR or NAND arrangement, and of relatively large (>1 Gbyte) size, in an integrated circuit separate from applications processor 22. In this example, non-volatile memory 31 is useful for storing persistent data used by applications processor 22 in carrying out its various functions. For example, in the cellphone context, non-volatile memory 31 may be used to store an address book, into which the user has entered or uploaded names of “contacts” in association with telephone numbers, email addresses, physical addresses, photos, and the like. Non-volatile memory 31 may also be used to store various “profiles” that, in the cellphone context, define operating modes of smartphone 20. For example, a “normal” profile may specify a state in which smartphone 20 outputs a loud ringtone for incoming calls, without vibration, and another separate tone for incoming SMS messages, while a “meeting” profile may specify an operating state in which smartphone 20 is in a vibration-only mode for incoming calls, and a soft sound for incoming emails and SMS messages. As will be described below, more detailed calling profiles can be set up and stored in non-volatile memory 31 for use in connection with one of the embodiments of this invention.

Smartphone 20 includes hardware for various additional functions. In this example, one such function is realized by camera hardware C, which is coupled to applications processor 22 via camera interface 32. A typical implementation of camera hardware C includes a lens, a solid-state light sensor (e.g., charge-coupled-device), an electronic “shutter” that controls the duration over which the light sensor is active to capture an image, automatic exposure circuitry for determining this exposure duration based on sensed light from the scene, and other conventional circuitry and functionality for acquiring a digital still or video image. Smartphone 20 is powered from battery B, under the control and management of power management function 28. Power management function 28 may be realized as a separate integrated circuit (from applications processor 22) that controls and applies the appropriate system power from battery B to applications processor 22 and the other functions within smartphone 20, including the generation of any necessary regulated voltages. Power management function 28, as typical in the art, also can include power savings functionality, so that activation or backlight of display D and similar non-essential functions can be turned off after a time-out period. Other functions that are commonly included within power management function 28, as in conventional mobile handsets, include control of a vibrating indicator, interface to an on/off switch, display of a remaining-battery-power indication, and the like.

These various functions, including the interface functions, may be realized in one or more separate integrated circuits from applications processor 22. Or alternatively, some or more of these functions may be implemented into a single integrated circuit along with applications processor 22.

As known in the art and as mentioned above, most mobile telephone handsets such as smartphone 20 include an “address book” function or application, by way of which the user can create and manage a stored list of “contacts”, each contact associated with a name, one or more phone numbers, and perhaps additional information such as an email address, physical address, etc. The contents of such an address book are retained within one of the non-volatile memory resources of smartphone 22, for example within non-volatile memory 31 of FIG. 1. Contacts and the corresponding information may be entered by the user via keypad H, or by storing (on user request) information received along with a received call or email. Alternatively, the contents of this address book function may be acquired by synchronizing smartphone 22 with a computer, or by copying the address book contents from SIM card SIMCD or flash memory FM. On many smartphones, the user can associate each contact with a photo or other picture, which appears when making a call to or receiving a call from that contact; in addition, some mobile telephone handsets allow the user to associate a particular ringtone with a contact, thus providing an audible signal identifying that a particular contact is calling.

According to a first embodiment of this invention, this address book function of smartphone 20 is used by a calling party (the “caller”) to communicate ancillary information regarding the caller or the call, or both, to the intended receiving party (the “recipient”) of a call. It is contemplated that the recipient also will typically be using a mobile telephone handset in order to receive and display this ancillary information, although it is further contemplated that either or both of the caller and recipient may be using a land-line telephone (or, further in the alternative, a computer operating as a telephone), assuming that the telephone hardware has sufficient computational capability to perform the functions involved and assuming that the communications facilities are capable of carrying the ancillary information along with the voice call.

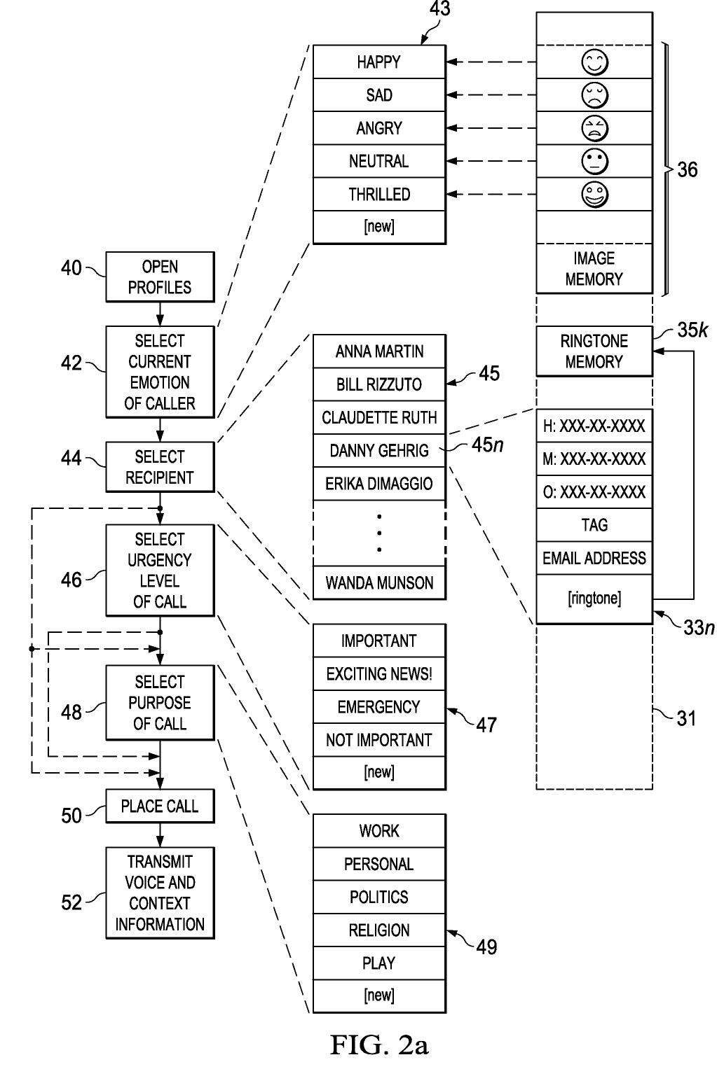

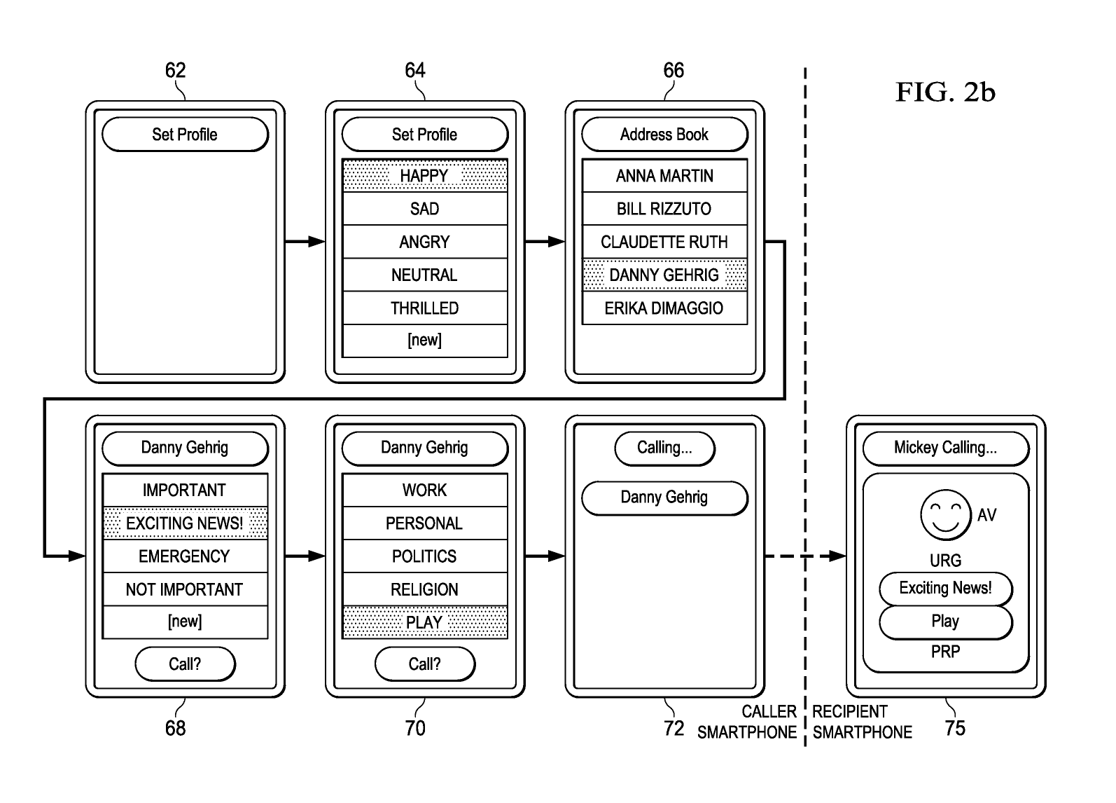

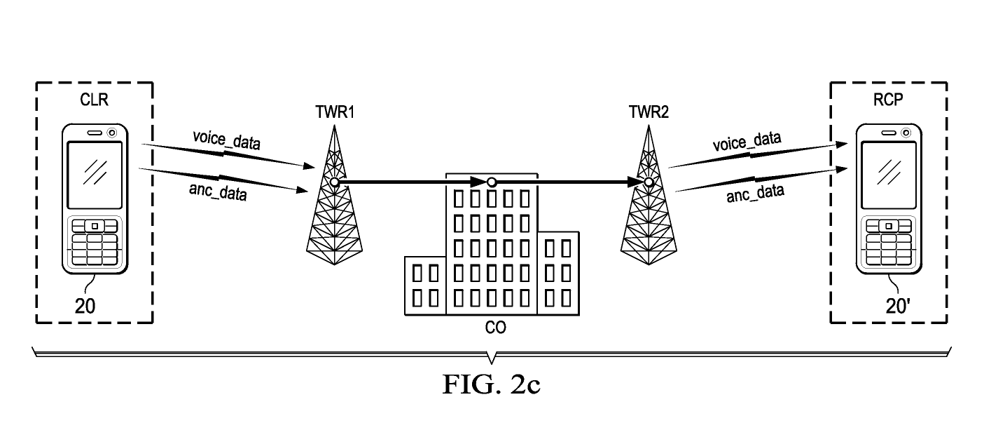

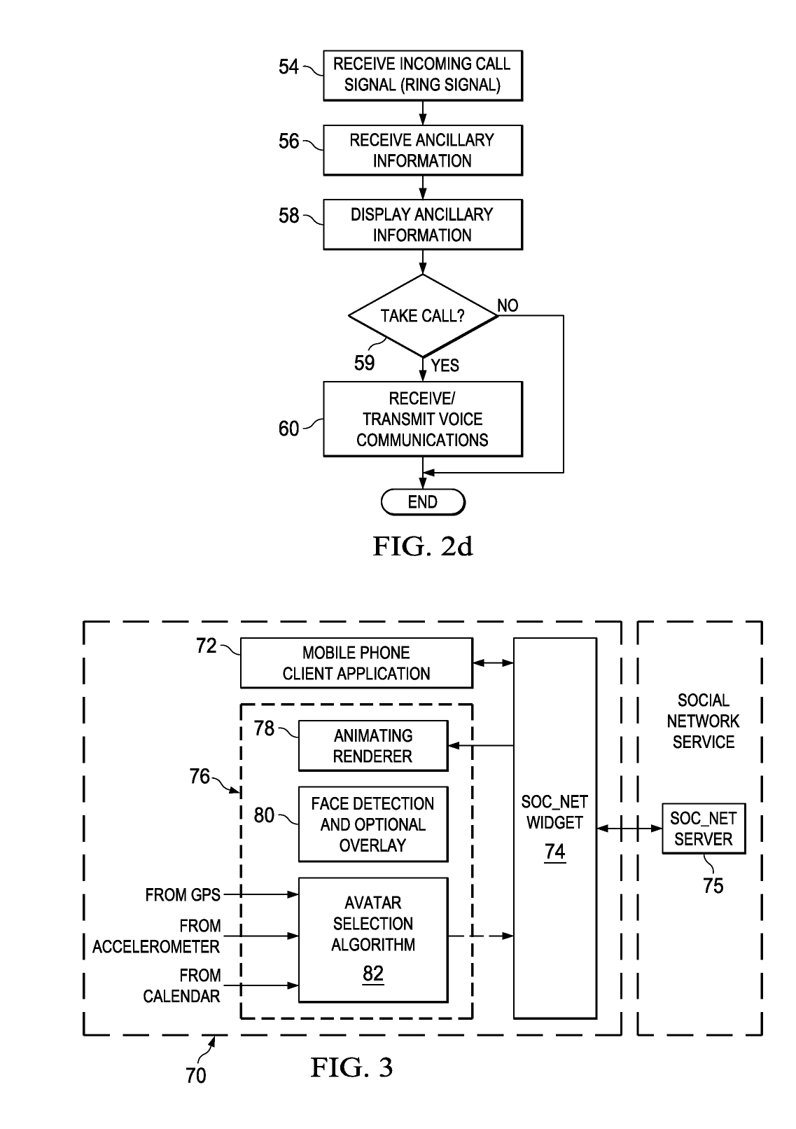

FIG. 2a illustrates the operation of smartphone 20 in placing a call including ancillary information, according to a first embodiment of this invention. This ancillary information includes information regarding the context of the call, for example the emotional state of the caller, the purpose of the call, and the urgency level of the call, and is communicated in a manner that not only conveys the non-verbal information to the recipient of the call, but also enables the recipient to decide whether or not to take the voice call in the first place (for example, the recipient may decline taking a personal call when in a business meeting, if the ancillary information conveys that the call is of a personal, and non-urgent, nature). FIG. 2b illustrates an example of the graphic content on display D of smartphone 20, which is placing the call, and of a display at the receiving mobile telephone handset, according to this embodiment of the invention.

In this embodiment of the invention, it is contemplated that computational circuitry within applications processor 22 will carry out the various steps and operations described in connection with this embodiment of the invention, for example by executing various computer program instructions as stored in program memory 25p or alternatively stored in non-volatile memory 31. According to this embodiment of the invention, as mentioned above, the particular architecture of applications processor 22 is not critical to carrying out this invention, nor is it particularly critical which computational resource within applications processor 22 in fact executes the corresponding instructions or alternatively carries out the functions described herein in some other manner, such as by way of custom or semi-custom logic. It is therefore contemplated that those skilled in the art having reference to this specification will be readily able to program or otherwise arrange the appropriate computational resources within smartphone 20 to carry out these functions, in a manner most appropriate with the particular architecture and capability of applications processor 22 or smartphone 20.

The process of smartphone 20 placing a call, according to this first embodiment of the invention, begins with process 40 in which the user of smartphone 20 begins selection of the ancillary information to be transmitted with or in advance of the call. In process 40, the caller (i.e., the user of the handset placing the call) operates smartphone 20 to open an application or function by way of which the caller can select an appropriate “profile” for the call that is about to be placed. Display image 62 (FIG. 2b ) illustrates an example of the contents displayed on display D of smartphone 20, as the caller operates to select such a profile—upon the caller choosing this “Set Profile” function, smartphone 20 displays the available emotion profile states on display D, as shown by display image 64 of FIG. 2b, to permit the caller to select a corresponding emotion for the call in process 42.

In process 42, as shown in FIG. 2a, the caller can select one of the available emotional states displayed on display D (image 64 of FIG. 2b), each of which is associated with a corresponding one of links 43 that points to one or more profiles stored on smartphone 20. In the example of FIG. 2a, emotional profiles 43 refer to pointers or other memory locations within smartphone 20, each of which is associated with a display term (e.g., “HAPPY”, “SAD”, etc.) and each of which, in this example, points to a location in image memory portion 36 of the overall memory space of non-volatile memory 31 and other memory resources within smartphone 20. In this way, the user selection of one of emotional profiles 43 in process 42 will also select other information, such as an image or sets of images (e.g., an animated “.gif” file) in image memory portion 36 that is associated with, and linked to, the selected profile 43. According to this embodiment of the invention, by way of example, this image will be communicated to the recipient of the call, functioning as an “avatar” that conveys the current emotional state of the caller, for example in lieu of displaying a word description of this current emotional state. The image may, of course, be a drawn or otherwise rendered image, or may alternatively be based on a photograph of the caller. It is, of course, contemplated that the word description or tag associated with the selected emotional profile 43 may alternatively be communicated to the recipient, but it is believed that the “avatar” approach will be preferred by most users. Display image 64 in FIG. 2b illustrates an example of the graphic result of process 42, in which the emotional profile “HAPPY” is selected by the caller.

As shown in FIGS. 2a and 2b, the available emotional profiles 43 include some profiles that have been previously defined by the manufacturer of smartphone 20 including this functionality, by the programmer of an application (“app”) by way of which this ancillary information functionality is incorporated into smartphone 20, or in a user-definable manner by the caller or other user of smartphone 20. In addition, in this example, the caller can define and select a new emotional profile in process 42, by way of selecting the “[new]” profile 43 and then setting up the appropriate links and other ancillary information. For example, smartphone 20 may initiate a “wizard” or other user-friendly function by way of which the caller can define and select this new emotional profile 43.

Alternatively, the particular status selected in process 42 may simply select a most recent media file captured (via camera function C) or otherwise rendered by the user, for transmission as an image or avatar. The selection of one or more media files for transmission as the caller status may be presented as an option within display image 64 of FIG. 2b, or smartphone 20 may be configured so that it automatically selects that most recently captured or rendered media file without user selection. In either case, the caller can use this approach to easily update their current emotional status simply by capturing a digital photo of their current location (e.g., office desk, beach, golf course, home). It is contemplated that smartphone 20 may provide some sort of locked or private status of captured or rendered media files, so that the user can prevent the use of a particular media file, if desired.

Further alternative sources and uses for the transmission of a recent media file are also contemplated according to this embodiment of the invention. For example, the image that may be selected as the most recent media file may be a recent screen capture from an application being executed by smartphone 20, for example a web browser, presentation application, spreadsheet, or word processing document. A particularly useful example of this screen capture would be an error message output by smartphone 20, for use in calling support personnel. By transmitting such a screen capture as an avatar or other image in placing a call, the recipient will be made aware of the specific context of the call. This screen capture may be made automatically by smartphone 20 (i.e., simply capturing the current state of the mobile desktop, ignoring the dialing application), or by some sort of user selection process. According to another alternative, it is also contemplated that the selected media file may be an audio file, such as a recently listened-to .mp3 audio file, in which case a short sample of the audio file may be transmitted with the image or avatar. It is contemplated that those skilled in the art having reference to this specification will recognize other image sources useful to be transmitted by smartphone 20 along with the call being placed.

Referring back to FIG. 2a, smartphone 20 then executes process 44 in this example, by way of which the caller selects an intended recipient for the call. In this example, recipient selection process 44 is performed using the “address book” function of smartphone 20. As known in the art and as described above, the address book function accesses contact list 45, which is stored in non-volatile memory 31 or another memory resource within smartphone 20. Contact list 45 includes a number of entries, each of which being referred to by a contact name (e.g., “ANNA MARTIN”, etc. as shown in FIG. 2a), and which links to contact information 33 stored at a location within the overall memory space of non-volatile memory 31 and other memory resources within smartphone 20. In the example illustrated in FIG. 2a, each contact 45n (e.g., “DANNY GEHRIG”) links to an associated entry 33n in non-volatile memory 31. Entry 33n includes various phone numbers, such as a home phone number, a mobile phone number, an office phone number, and the like for that particular contact 45n, as well as an email address, a user-definable “TAG” that associates contact 45n with a group of similar contacts (e.g., “WORK”, “PERSONAL”, etc.), and may also include a link to a specific ringtone stored within ringtone memory portion 35k of non-volatile memory 31. Display image 66 of FIG. 2b illustrates an example of display D, indicating a result of process 44 in which contact “DANNY GEHRIG” is selected by the caller. Alternatively, of course, the user may simply enter a phone number of the intended recipient of the call, if that recipient is not yet (or will never be) stored in the address book of smartphone 20.

Referring back to FIG. 2a, process 46 is next performed by smartphone 20, by way of which the caller selects an urgency level for the call to be placed. Smartphone 20 may include several available urgency profiles 47 (e.g., “IMPORTANT”, “EMERGENCY”, etc.), for example as pre-stored by the manufacturer or the application programmer within non-volatile memory 31 or another memory resource, and may also include one or more urgency profiles 47 that are stored by the user of smartphone 20 (e.g., “IMPORTANT NEWS!”). As shown in FIG. 2a, process 46 also includes the ability for the user to define a new urgency profile 47, by selecting the “[new]” profile 47 and then following a menu or wizard-based process to define the name and other attributes of this new profile 47, such attributes including whether to store the new profile for later use or not (in which case the new urgency profile will be used only for this call). Display image 68 of FIG. 2b illustrates an example of the output to the caller from smartphone 20, in which the “EXCITING NEWS!” urgency profile was selected in process 48, and will be used for the call to selected recipient “DANNY GEHRIG”.

Process 48 (FIG. 2a) is also executed by smartphone 20 in this embodiment of the invention, by way of which the caller can select one of a set of purpose profiles 49 to be associated with the call. In this example, purpose profiles 49 similarly include several profiles (e.g., “WORK”, “PERSONAL”, etc.) pre-stored by the manufacturer or the application programmer within non-volatile memory 31 or another memory resource, and may also include one or more urgency profiles 47 that are defined and stored by the user of smartphone 20, for example by selecting the “[new]” purpose profile and following through the menu or wizard-based routine for defining the attributes of this new purpose profile 49. Each purpose profile 49 is associated with a name, and possibly one or more additional attributes linked to that name; a new user-defined purpose profile 49 can also have an attribute indicating that it is to remain persistently stored in smartphone 20 for later use, or if it is instead a special purpose profile for use in this call only. Display image 70 in FIG. 2b illustrates the example of this call to “DANNY GEHRIG” being prepared, in which the purpose profile 49 selected in process 48 is “PLAY”.

Each urgency profile 47 and purpose profile 49 may, if desired, be associated with and linked to a corresponding image or image attribute within non-volatile memory 31. In this manner, similarly as in the case of emotional profile 43, a visual representation associated with the urgency or purpose can be selected by selection of profiles 47, 49, and communicated to the recipient of the call in place of, or in addition to, a word description or tag of the corresponding urgency or purpose. Indeed, it is contemplated that such visual representations of urgency, purpose, or both could be combined with the avatar image corresponding to the selected emotional profile, to effectively render a composite image representative of all attributes of the ancillary or contextual information. For example, if the caller wants to convey that she is happy about an event at work, and wants to urgently contact the recipient about that event, a composite “avatar” could be rendered, illustrating a foreground “happy face” image in front of an office building background, with an exclamation mark overlaid into the image.

The particular order in which processes 42, 44, 46, 48 is performed is of no specific importance, and indeed these processes 42, 44, 46, 48 may be performed in any order. It is contemplated, however, that such ancillary information such as the urgency of the call and the purpose of the call may, in a variation on this embodiment of the invention, take default values that vary with the contact being called. For example, the contact information associated with the caller's work supervisor may have a default purpose profile 49 (e.g., “WORK”), and a default urgency profile 47 (e.g., “IMPORTANT”). It is also contemplated that, in some implementations, it may be useful to arrange smartphone 20 so that some urgency or purpose profiles are prohibited from being attached to certain contacts (e.g., smartphone 20 may prohibit the selecting or sending of the “POLITICS” purpose profile 49 to the caller's work supervisor). These and other variations will be apparent to those skilled in the art having reference to this specification.

In this example of this embodiment of the invention, after selection of the emotional profile 43 in process 42, selection of the contact 45 to be called in process 44, selection of the urgency profile 47 in process 46, and selection of the purpose profile 49 in process 48, the call is then placed in process 50. In the example of the display images in FIG. 2b, the call is placed by the caller (user) selecting the “CALL?” button on smartphone display D at any point at which it is presented (e.g., at either of display images 68 or 70 in this example). As evident from the availability of the “CALL?” button in these display images 68, 70, selection processes 46, 48 are optional, and can be skipped if desired by the caller. Following placement of the call by the caller in process 50, process 52 is performed by smartphone 20 to transmit the ancillary information including the selected emotional profile 43 (and one or more images 36 associated therewith), the selected urgency profile 47, and the selected purpose profile 49, along with the voice payload of the call, to the desired recipient (i.e., contact 45) selected in process 44.

FIG. 2c illustrates a simplified example of the manner in which the voice payload and ancillary information are transmitted over the cellular telephone network, for the case in which both the caller and the recipient are using mobile telephone handsets with smartphone capabilities as described above in connection with smartphone 20. In the illustration of FIG. 2c, caller CLR transmits the voice payload portion of the call over one communications channel voice_data, and transmits the ancillary information including the selected profiles (emotion, urgency, purpose) over another communications channel anc_data, both transmissions made from smartphone 20. Communications channel anc_data may be realized by way of an associated digital data channel encoded or otherwise transmitted with voice channel voice_data, such as the channel over which “caller ID” information is transmitted, or alternatively may be transmitted by way of an entirely separate channel, such as an Internet Protocol (IP) communications channel (e.g., similar to an “IM” or Internet Messenger message), or similarly as a multimedia text message under the SMS protocol. In any case, both transmissions over communications channels voice_data, anc_data are transmitted from smartphone 20 to a nearby appropriate cellular tower TWR1, and from tower TWR1 (either directly or indirectly) to the telephone company central office CO. The call is then communicated from central office CO in the conventional manner, for this example in which the recipient is specified by a mobile phone number, to cellular tower TWR2 to which smartphone 20′ of recipient RCP is currently mapped. Communications channels voice_data and anc_data between cellular tower TWR2 and smartphone 20′ of recipient RCP carry the voice payload and ancillary information, respectively, that were originally transmitted by caller CLR via smartphone 20. Of course, depending on the type of communications channel anc_data used to communicate the ancillary information, the overall path for the two types of communications can differ, and may proceed via different communications facilities.

FIG. 2d illustrates the operation of a receiving mobile telephone handset, which may be another instance of smartphone 20 (such as smartphone 20′ in FIG. 2c) or alternatively another handset with the necessary capability, as described herein, in receiving a call that includes ancillary information, according to this first embodiment of the invention. It is contemplated that the receiving telephone can be implemented according to any one of a number of possible realizations. For example, the receiving telephone may be a land-line telephone handset, which may or may not have the capability of receiving the ancillary information; in that event, only the voice payload transmitted by smartphone 20 in process 52 will be received by the recipient, and the phone call will be carried out in the conventional manner. Alternatively, the receiving telephone may be a mobile telephone (e.g., another instance of smartphone 20, or alternatively a conventional mobile telephone handset), or an advanced digital land-line telephone, or even a personal computer workstation with telephone functionality, any one of which having the capability of displaying the ancillary information transmitted in process 52. The process of FIG. 2d illustrated in this example is provided for the case in which the receiving telephone is similar to smartphone 20, to the extent that it can receive and display the ancillary information transmitted in process 52 and can permit the recipient user to make decisions regarding the call in response to that ancillary information, prior to taking the call.

In this example of this embodiment of the invention, receiving smartphone 20′ receives an incoming ring signal from the telephone network in process 54, indicating that a call has been placed to the phone number associated with receiving smartphone 20′. In process 56, receiving smartphone 20′ receives the ancillary information communicated from calling smartphone 20, over the secondary communication channel anc_data or otherwise, and in process 58, smartphone 20′ displays that ancillary information on its display D. Display image 75 of FIG. 2b shows an example of the display of this ancillary information. As shown in display image 75, the identity of the caller (e.g., “MICKEY”) is displayed, either from the caller ID information transmitted with the call, or alternatively by smartphone 20′ matching the incoming phone number (from the caller ID information) with one of the contacts in its address book. As shown in FIG. 2b by way of display image 75, the additional ancillary information includes avatar AV, which conveys information regarding the current emotional state of caller CLR as selected in process 42. Avatar AV is contemplated to provide a visual representation of the current emotional state of caller CLR, and as such may be a single image conveying this emotional state (e.g., the “happy face” in display image 75 indicating a happy emotional state), or an animated series of images (e.g., an animated .gif file) displayed in a loop fashion, with the images either being graphical images, photographs (original or modified), or other visual representations of this emotional state. Avatar AV need not necessarily represent a human face, but may convey the emotional state indirectly; for example, a photograph of a garden may communicate a serene emotional state on the part of caller CLR. It is contemplated that the particular selection of avatar AV for a particular emotional state can vary widely, limited only by the human imagination. In this embodiment of the invention, it is contemplated that the images of avatar AV itself are communicated from smartphone 20 over communications channels anc_data in the manner shown in FIG. 2c; alternatively, it is also contemplated that avatar images may be locally stored at receiving smartphone 20′, and retrieved for display by receiving smartphone 20′ in response to a label or tag communicated by calling smartphone 20 over communications channels anc_data. And as mentioned above, in the alternative to avatar AV being displayed in process 56 to convey emotional state, it is contemplated that receiving smartphone 20′ may receive and display a word tag or description of the emotional profile selected by caller CLR.

Also in this example, additional ancillary information is communicated by calling smartphone 20 to receiving smartphone 20′, over communications channels anc_data. This additional ancillary information received by receiving smartphone 20′ in process 54 and displayed in process 56 includes urgency attribute URG, which conveys information regarding the urgency level selected by caller CLR in process 46, and purpose attribute PUR, which conveys information regarding the subject matter or purpose of the call, again as selected by and thus from the viewpoint of caller CLR. These attributes URG, PUR are shown in display image 75 of FIG. 2d as communicated by a word tag for each. Alternatively, it is contemplated that smartphone 20′ may modify avatar AV to display features or colors, or the like, in a composite image with avatar AV. For example, a background in the displayed image may be selected according to the purpose attribute PUR, and another foreground image (with avatar AV) may be selected and displayed according to the urgency attribute URG.

As discussed above, in the alternative or in addition to these sources of ancillary information, it is contemplated that screen capture images from the calling smartphone 20 may be received and displayed by receiving smartphone 20′. Also as discussed above, it is also contemplated that audio file snips, for example from the most recent audio file listened to by the caller, may be received by receiving smartphone 20′ in connection with the call, and output as the ringtone or as a subsequent audio sound, as another part of the overall ancillary information.

Referring back to FIG. 2d, after the display of the received ancillary information in process 58, relative to an incoming call, recipient RCP has a great deal of information that may be useful in deciding whether to take the call. In this example, recipient RCP has the name of caller CLR (via caller ID), the emotional state of caller CLR (via avatar AV), the urgency that caller CLR has assigned to the call (via urgency attribute URG), and the purpose of the call (via purpose attribute PUR), such ancillary information being conveyed directly by words or indirectly by visual indicators such as pictures, photos, graphic art, etc. Based on that information, recipient RCP decides whether to take the call, in process 59; typically, it is contemplated that the current environment of recipient RCP will be a substantial factor in that decision, but decision 59 can be made for any reason whatsoever. If recipient RCP takes the call (decision 59 is yes), for example by pressing a key on smartphone 20′, then voice communications within the context of the call take place, in process 60, in the conventional manner. If recipient RCP does not take the call (decision 59 is no), for example by pressing a different key on smartphone 20′ or simply by failing to answer the incoming call, the process ends in the usual manner for refused or otherwise missed calls.

In an alternative implementation, assuming sufficient capability on the part of receiving smartphone 20′, recipient RCP may select and transmit ancillary information regarding recipient's own current emotional state, for example following process 42 described above, as well as any other ancillary information that would not be redundant with that transmitted by caller CLR (e.g., the purpose of the call was established by caller CLR). This transmission of ancillary information from recipient RCP to caller CLR can accompany voice communications if the call is accepted (decision 59 is yes), and may also be transmitted by receiving smartphone 20′ if the call is rejected (decision 59 is no), to provide caller CLR with a reason why the call was not taken.

Further in the alternative, it is contemplated that calling smartphone 20 can update the avatar or image transmitted to receiving smartphone 20′ once the call is accepted and during the call. These additional updated images may be transmitted over communications channel anc_data, separately from the voice communications channel voice_data. This ability to update the transmitted images can effectively create a “netmeeting” type of function, such that both visual and voice information can be readily exchanged between the caller and recipient.

According to this embodiment of the invention, therefore, ancillary information is communicated from a caller's phone to an intended recipient's phone, along with the voice communications. This ancillary information can be used by the recipient in determining whether to accept an incoming call, and is also important to the recipient once the call is taken, because knowledge of the context, emotions, and purpose of the call can be useful in responding to the call in a more appropriate and productive manner. Communications are therefore enhanced, made more productive, with awkward misunderstandings avoided.

As evident from the foregoing, the ancillary information regarding the caller and the context of the call is communicated from the caller's smartphone 20 to the recipient's smartphone 20′ or other telephone handset, in that first embodiment of the invention. While this contextual information greatly enhances the communication, that communication requires actions to be taken by the calling party. According to other embodiments of this invention, ancillary information regarding the caller is conveyed automatically to the recipient, without requiring action on the part of the caller to select and convey that information, by taking advantage of online social networking services.

As known in the art, online social networking services and websites have become popular in recent years. Examples of popular online social networking services include the FACEBOOK, MYSPACE, LINKEDIN, and TWITTER social networking services, as well as similar services. Each of these and other social networking services provide its users with the ability to post very current information about themselves, such current information including a current emotional state, a description of what the user is currently doing or the location of the user, and the like.

Many users of these social networking services are quite disciplined in updating their personal status. In addition, some smartphone or other applications assist the user in automatically updating their status on the social networking service. For example, smartphone applications are available in the marketplace that automatically update the status of a social network user with the most recent digital picture captured by the user via the user's smartphone—all users need do in order to update their status is to take a cellphone picture of their current location (e.g., on the beach, at their desk or workplace, etc.), and the application forwards the photo to the social networking site. Regardless of the manner and frequency with which social networking users update their status, according to these embodiments of the invention, the user status on the social networking service is accessed in order to provide the ancillary and contextual information regarding a voice phone call, without requiring parties to expressly define and communicate that status and information in addition to making or receiving the call.

An example of software environment 70 within smartphone 20, according to these embodiments of the invention in which ancillary information is acquired from social networking services, is shown in FIG. 3. Software environment 70 includes various software programs that are executable by applications processor 22, and are stored in program memory 25p, in other memory resources such as non-volatile memory 31, or some combination of those resources. Mobile phone client application 72 within software environment 70 constitutes the primary software function according to which smartphone 20 places and receives calls, and includes (or cooperates with) the address book, text messaging, and other similar functions.

According to these embodiments of the invention, mobile phone client application 72 communicates with social network “widget” application 74 to access a social network service. For example, mobile phone client application 72 can forward an address book contact name to social network widget 74, which in turn queries one or more social networking services or websites to retrieve information regarding that contact. The address book contact forwarded by mobile phone client application 72 can include a link to a social network website or other identifying information regarding the address book contact, to facilitate such access by widget 74 or, if different widgets 74 within software environment 70 are each dedicated to specific social networking services, to select the appropriate widget 74. In this example, social network server application 75 within and located at the social network service retrieves the information requested by widget 74, and forwards that information to widget 74. Widget 74 in turns provides mobile phone client application 72 and other applications within software environment 70 with the requested information regarding the contact.

Avatar rendering software 76 is also provided within software environment 70 of smartphone 20 in these embodiments of the invention. Avatar rendering software 76 is responsible for generating an avatar or other visual indicator from the status and other information obtained from the social networking service by widget 74, for presentation on display D in connection with a voice call. In the example illustrated in FIG. 3, several options useful in connection with avatar rendering software 76 are illustrated; it is contemplated that one or more of these or similar options may be provided within a particular implementation of smartphone 20, depending on the desired functionality. However, it is contemplated that these examples will provide those skilled in the art having reference to this specification with the overall functionality that is desired in connection with generation of a visual representation or avatar at display D.

In this example, animating renderer 78 within avatar rendering software 76 is a software application, executable by applications processor 22, that converts the status information acquired by social network widget 74 into an avatar that is displayable on display D. The complexity of the avatar rendered by animating renderer 78 can vary widely. For example, renderer 78 may generate a simple “smiley face” type of avatar corresponding to an emotional status (“happy”, “sad”, etc.) retrieved from the social networking service. More complex avatars that can be generated by renderer 78 may include animations of stored cartoon representations, color generation, and other visual indications of the emotional state of the contact; in addition, if the status information retrieved from the social networking service includes location or activity information, renderer 78 may generate backgrounds (i.e., an office environment background for the animated avatar) or other visual representations regarding location or activity. If the status information retrieved by widget 74 includes a recent photograph taken by the contact, animating renderer 78 may instead simply reformat that photograph for the resolution and aspect ratio of display D.

Face detection and optional overlay function 80 provides even more advanced graphical or video representations of the status information regarding the address book contact, based on the information retrieved from the social networking service by widget 74. For example, smartphone 20 may have stored, in its non-volatile memory 31, digital photos that are linked by the user to several ones of the address book contacts, so that a particular photo appears on the display when that person is calling the user or being called by that user. If the address book contact for which status information is obtained by widget 74 from the social networking service is associated with a photo, face detection and optional overlay function 80 can overlay the associated photo onto a background corresponding to the status or location of that person, if a call is being placed to or received from that contact. Other more advanced operations may also be performed by face detection and optional overlay function 80, for example by detecting and altering the facial expression of the contact's photo according to the retrieved status information.

Another optional software function provided by software environment 70 in this example is shown by way of avatar selection algorithm 82, which in this example, generates an avatar for the user of smartphone 20 himself or herself, for uploading to one or more social networking services via widget 74. By uploading such an avatar, which includes status or emotional information as will be described, other parties with whom the user of smartphone 20 is communicating can receive the avatar and ancillary information if those other parties are using a mobile telephone handset equipped with that functionality. It is contemplated that avatar selection algorithm 82 can interface with various functions of smartphone 20 in order to automatically generate an avatar for the user of smartphone 20, without requiring user intervention to do so. FIG. 3 illustrates examples of such interfacing to receive Global Positioning System (GPS) information from GPS receiver 33, accelerometer data, and calendar information. Examples of the generation of an avatar or other visual indicator by avatar selection algorithm 82 from these inputs will be described in further detail below.

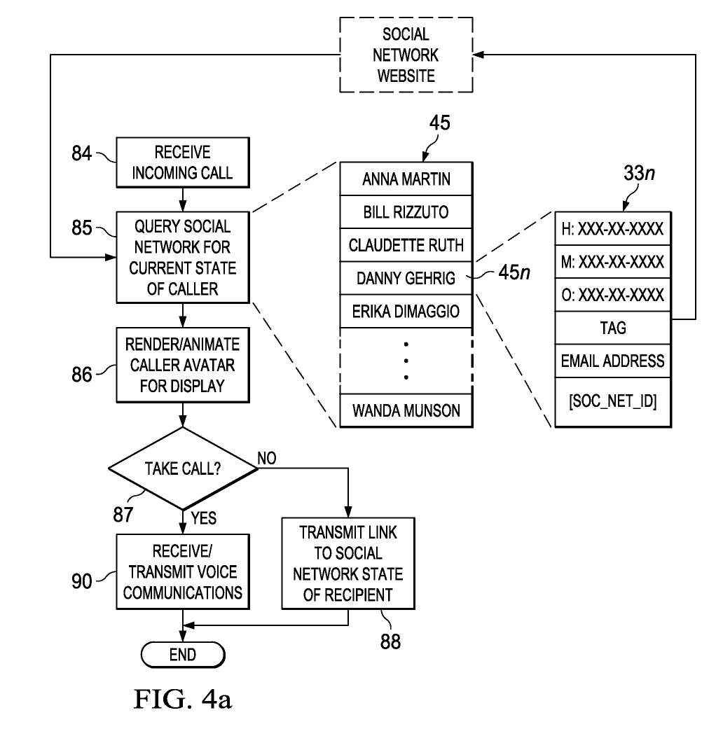

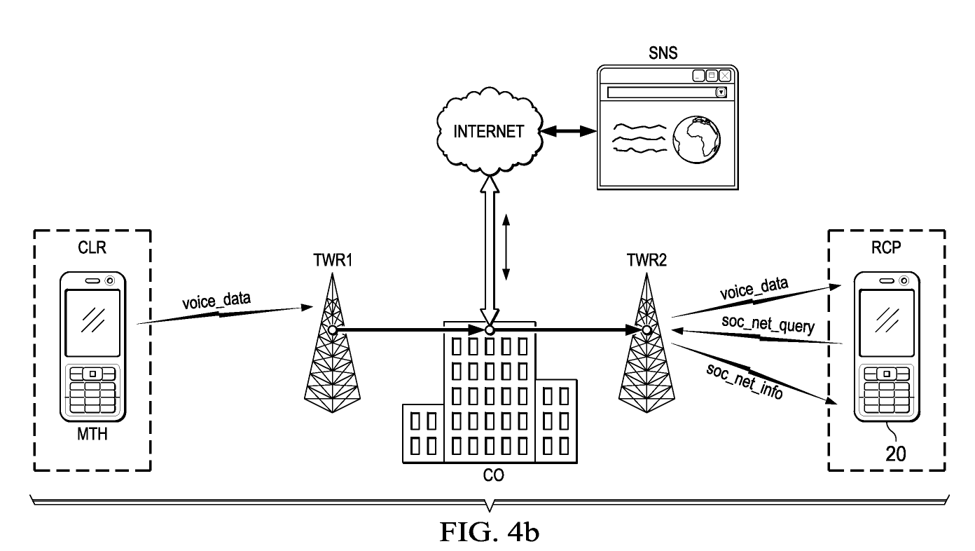

Referring now to FIG. 4a, the operation of smartphone 20 including software environment 70, in accessing and displaying ancillary information from a social networking service in connection with an incoming call, will now be described. As will be evident from this description, the caller need not actively select or configure any of the ancillary information communicated to the recipient of a call being placed by the caller, and indeed may not be aware that the recipient has acquired this ancillary information.

In process 84, smartphone 20 receives the incoming call, more specifically by receiving the incoming “ring” signal. In connection with process 84, mobile phone client application 72 executes its usual functions in connection with an incoming phone call, including receiving and displaying any caller ID information, comparing the incoming caller ID information with the list of contacts in contact list 45, activating a ringtone according to the current settings of smartphone 20 (including selecting any special ringtone linked to the incoming caller ID), and the like.

According to this embodiment of the invention, smartphone 20 also executes program instructions stored in program memory 25p or in another memory resource (e.g., non-volatile memory 31) to obtain ancillary information about the caller from whom the incoming call is being received. This is performed in process 85, in which smartphone 20 accesses a social networking service with which the caller is subscribed. As mentioned above, conventional functions within mobile phone client application 72 of smartphone 20 compares the incoming caller ID information (name, phone number, etc.) with contact list 45 to determine whether the caller matches a contact stored in contact list 45. In this embodiment of the invention, entries 31 for the contacts stored in contact list 45 also include a social networking service identifier [SOC_NET_ID] that identifies one or more social networking services with which the caller is subscribed. Upon identifier [SOC_NET_ID] having an entry, in process 85, social network widget 74 accesses the social networking service using that identifier information, with a query regarding a current state of the caller. And also in process 85, widget 74 receives, from the social networking service, status and other associated information regarding the caller, in response to the query that it issued.

FIG. 4b illustrates the data flow according to this embodiment of the invention, and in particular illustrates the data flow by way of which information regarding caller CLR is acquired by recipient RCP using smartphone 20. Because caller CLR is merely placing a conventional voice phone call, caller CLR may be using a conventional land-line telephone, a personal computer or other digital device (hard-wired or wireless) serving as a VoIP telephone, a basic mobile telephone handset, or an instance of a smartphone similar to smartphone 20. In the example of FIG. 4b, caller CLR is placing this conventional voice phone call from mobile telephone handset MTH, the voice payload of which will be routed to smartphone 20 over wireless voice communications link voice_data to cellular tower TWR1, along a fiber optic or other facility from tower TWR1 to central office CO for switching and routing, from central office CO to cellular TWR2, and to smartphone 20 of recipient RCP via wireless voice communications link voice_data. In the example of smartphone 20 illustrated in FIG. 1, receiving smartphone 20 will be receiving the voice communications (once the call is taken) via antenna A1 and RF module 23.

In this embodiment of the invention, separate communications links soc_net_query and soc_net_info are used to request and receive ancillary information regarding caller CLR from the social networking service indicated in connection with the contact information of caller CLR. As shown in FIG. 4b, communications link soc_net_query carries the query by widget 74 to cellular tower TWR2, and communications link soc_net_info carries the status and ancillary information from cellular tower TWR2 back to smartphone 20. In the example of smartphone 20 of FIG. 1, these communications via communications links soc net query and soc_net_info may be carried out at a different physical port from the voice data, for example via antenna A2 and 3G/4G modem 30, particularly in the case in which the query and response are executed as IP communications rather than over the cellular link. As shown in FIG. 4b, in this example, tower TWR2 also communicates the ancillary information query and response via central office CO. In the case of the social networking service query and response, however, central office CO routes the query communications link soc_net_query to the Internet, accessing the social networking service SNS according to its associated IP address etc. The ancillary information received from social networking service SNS in response to that query is routed back to smartphone 20 of recipient RCP via the Internet, central office CO, cellular tower TWR2, and communication link soc_net_info.

It is contemplated that various types of ancillary information may be received by smartphone 20 in process 84, in response to a query issued by widget 74. The particular information communicated will likely vary depending on the service being queried. For example, the FACEBOOK social networking service supports a “micro-blogging” feature referred to as “status updates”, in which the subscriber posts short statements conveying current status information, such as their current location, what the subscriber is currently doing, or recent opinions or ideas; in addition, the FACEBOOK service supports the uploading of photos. The TWITTER social networking service similarly consists of short messages or updates posted by the subscribers. It is contemplated that these, and other current and future social networking services, can be readily accessed by widget 74 to acquire current status information, which may simply be the most recent status or update of the subscriber, a particular field within the subscriber's page, or if smartphone 20 is sufficiently capable, a screenshot of the subscriber's current page with the social networking service. In any event, it is contemplated that the query and response will often be sufficient to convey a current status, location, and the like of caller CLR to smartphone 20.

Referring back to FIG. 4a, process 86 is next executed by smartphone 20 of recipient RCP, to generate an avatar or other visual indicator representative of the ancillary information received from the social networking service. In software environment 70 of smartphone 20 shown in FIG. 3, widget 74 communicates the ancillary information from the social networking service to avatar rendering software 76, which generates this visual indicator. For example, animating renderer 78 can, if available, generate a cartoon or other still or animated image using clip art or other images stored within smartphone 20, with the selection or generation of these images based on the status of caller CLR obtained from the social networking service. Alternatively, the more sophisticated face detection and optional overlay function 80 may generate an avatar from a stored cellphone photo of caller CLR, to which entry 31 of contact list 45 links, for example by displaying that photo with an alteration, color, or the like, or by detecting the face of caller CLR in a most recent photo uploaded to the social networking service and retrieved via widget 74. Alternatively, or in addition, face detection and optional overlay function 80 may place the photo or avatar over a current photo retrieved from the social networking service, providing recipient RCP with an indication of the location or current activity of caller CLR. Or more directly, avatar rendering software 76 may simply generate the avatar or visual indicator by merely formatting an image retrieved from the social networking service by widget 74, so that the image fits display D of smartphone 20. In any case, in process 86, smartphone 20 displays the avatar rendered in process 86 on display D of smartphone 20, for viewing by recipient RCP prior to taking the call, according to this embodiment of the invention.

In decision 87, recipient RCP decides whether to take the incoming call. Ancillary information, such as current status or current location of caller CLR, is useful to recipient RCP in making this decision, particularly in combination with the location and current activity and emotional state of recipient RCP. If recipient RCP chooses not to take the call, smartphone 20 can execute optional process 88, by transmitting to caller CLR a link to the social networking service to which recipient RCP subscribes, so that caller CLR can obtain information regarding why recipient RCP refused the call (e.g., by checking the current status or location of recipient RCP). Alternatively, recipient RCP can send an SMS message to caller CLR by way of the usual SMS functionality within mobile phone client application 72. Upon recipient RCP not taking the incoming call (decision 87 is no), and any communications from optional process 88 to caller CLR, the call session ends.

Conversely, if recipient RCP decides to take the incoming call (decision 87 is yes), then process 90 is performed by smartphone 20 to receive and transmit voice communications in the conventional manner. However, during process 90 according to this embodiment of the invention, the avatar generated and displayed in process 86 can remain available at display D, from which recipient RCP can obtain ancillary information concerning the emotional state, location, current activity, and the like of caller CLR. Alternatively or in addition, a link to the social networking service to which caller CLR subscribes (and to which a reference or link is provided within entry 31 in contact list 45 for caller CLR) can be displayed at display D of smartphone 20, to facilitate access by recipient RCP to that social networking service via 3G/4G modem 30, a WiFi link, or the like during the voice call. In that regard, it is particularly useful that smartphone 20 be capable of multitasking during a voice call, to permit Internet access simultaneously with voice communications during the call. Additional ancillary information regarding caller CLR is thus facilitated, according to this invention.

This embodiment of the invention thus provides the recipient of an incoming call with relevant ancillary information regarding the caller of an incoming call, without requiring the caller to select or transmit the ancillary information. Rather, the current status and emotional state can be taken or deduced from recent activity at a social networking service or website, and automatically acquired by the receiving mobile telephone handset, without requiring interaction with the caller other than via the voice communications.

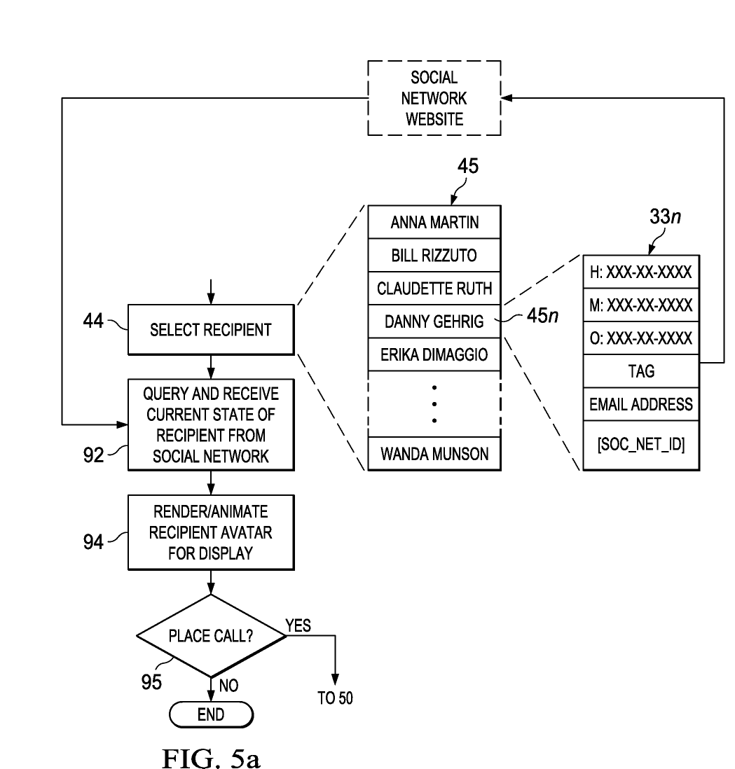

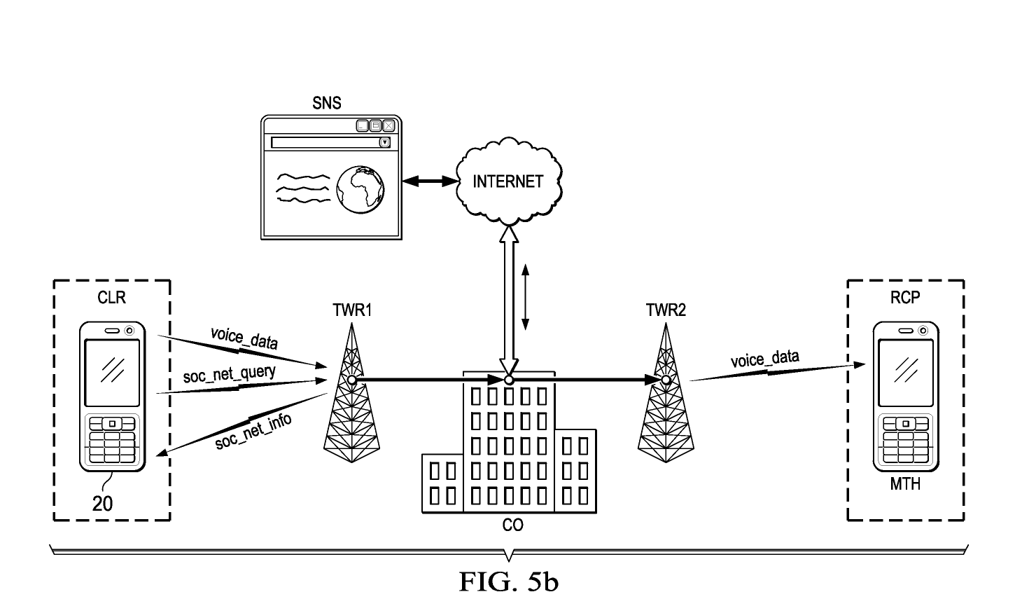

According to another embodiment of the invention, as will now be described in connection with FIGS. 5a and 5b, social networking services are automatically accessed by the caller to obtain ancillary information about the intended recipient of a voice call, to provide the caller with information regarding the current emotional state, current location, current activity, and other status of the recipient. Such ancillary information can be quite useful to the caller, particularly in determining whether to place the call at all, and also so that the caller can use an appropriate tone of voice and content during the call.

This embodiment of the invention can follow the overall process flow described above in connection with FIG. 2a, by way of which smartphone 20 places a voice call to an intended recipient. However, in this embodiment of the invention, the transmission of ancillary information regarding the caller is optional; in other words, the caller may choose to transmit no ancillary information, but may execute the processes illustrated in FIG. 5a to acquire ancillary information regarding the recipient. In process 44, as before, an intended recipient is selected for the potential call, for example using the “address book” function within mobile phone client application 72 of smartphone 20, to select a recipient from contact list 45 stored in non-volatile memory 31 or in another memory resource within smartphone 20. In this embodiment of the invention, one or more of contacts 45 (e.g., “DANNY GEHRIG”) are associated with a corresponding entry 33n in non-volatile memory 31 that also includes an identifier link [SOC_NET_ID] to a social networking service and that identifies the subscriber corresponding to that contact.

In process 92, smartphone 20 queries the social networking service with the contents of identifier [SOC_NET_ID] in selected entry 33n for the intended recipient, and receives status and other associated information regarding that recipient from the corresponding social networking service. For smartphone 20 including software environment 70 as discussed above relative to FIG. 3, it is again contemplated that widget 74 will construct and issue the query to the social networking service, and that server 75 will forward the status and other ancillary information from the social networking service to widget 74, which in turn will forward that data to mobile phone client application 72 and to avatar rendering software 76, in the manner described above. The various types of ancillary information provided by the social networking service to smartphone 20 in process 92 corresponds to that described above in connection with FIG. 4a, and again will depend on the features of the particular social networking service and also the information that has been provided by the intended recipient to that social networking service.

FIG. 5b illustrates the data flow according to this embodiment of the invention, in which information regarding intended recipient RCP is acquired by caller CLR using smartphone 20. In this example, caller CLR is using smartphone 20, which has the capability of carrying out the processes described above relative to FIG. 5a to acquire ancillary information regarding intended recipient RCP of the call. Conversely, because recipient need only receive, at most, a conventional voice phone call, recipient RCP may be using a conventional land-line telephone, a personal computer or other digital device (hard-wired or wireless) serving as a VoIP telephone, a basic mobile telephone handset, or an instance of a smartphone similar to smartphone 20; in the example of FIG. 5b, recipient RCP is using mobile telephone handset MTH. As in the case of FIG. 4b, voice payload is routed between smartphone 20 of caller CLR and mobile telephone handset MTH of recipient RCP over wireless voice communications links voice_data via cellular towers TWR1, TWR2, in combination with fiber optic or other facilities between towers TWR1, TWR2 and central office CO. For smartphone 20 constructed as shown in FIG. 1, voice communications (once the call is placed and answered) are carried out via antenna A1 and RF module 23.

Separate communications links soc_net_query and soc_net_info are used to request and receive ancillary information regarding recipient RCP from the social networking service indicated in connection with the associated link [SOC_NET_ID] in address book entry 45n. Communications links soc_net_query and soc_net_info carries the query and response, respectively, to and from cellular tower TWR1, for example using for smartphone 20 of FIG. 1. Tower TWR1 communicates the ancillary information query and response via central office CO, which in turn accesses social networking service SNS at its IP address etc. communicated from smartphone 20, with the results forwarded back to smartphone 20 via communications link soc_net_query, and antenna A2 and 3G/4G modem 30 in this example.

Referring back to FIG. 5a, process 94 is next executed by smartphone 20 to generate an avatar or other visual indicator to caller CLR, such an avatar or indicator being representative of the ancillary information received from the social networking service concerning recipient RCP. In software environment 70 of smartphone 20 shown in FIG. 3, process 94 is performed by avatar rendering software 76 in response to widget 74 communicating the ancillary information from social networking service SNS. The software elements of animating renderer 78 or face detection and optional overlay function 80 described above, if available, generate this avatar or other visual indicator in the same fashion as described above in connection with FIG. 4a. Indeed, it is contemplated that these software elements 78, 80 will operate is essentially if not exactly the same manner regardless of whether the query concerns an intended recipient of a call being placed from smartphone 20, or the caller of an incoming call to smartphone 20. In either case, smartphone 20 displays the avatar rendered in process 94 on display D of smartphone 20, for viewing by caller CLR prior to placing the call to intended recipient RCP, according to this embodiment of the invention.

In decision 95, caller CLR decides whether to place the call, using the ancillary information communicated from social networking service SNS, and expressed on display D, such information corresponding to intended recipient RCP. If not (decision 95 is no), then the call is not placed and the operation of smartphone 20 ends. If caller CLR still intends to place the call (decision 95 is yes), control passes to process 50 (FIG. 2a) to initiate the call. In the event that the call is placed, it is contemplated that the ancillary information regarding the current status, emotional state, location, and activity of intended recipient RCP will be useful to caller CLR in adopting the appropriate tone or topic of conversation in the voice call being placed. And in this embodiment of the invention, this ancillary information is provided automatically to caller CLR via smartphone 20, without requiring any additional action on the part of recipient RCP, other than maintaining as current the social networking service information (which, presumably, recipient RCP is doing anyway).

According to another embodiment of the invention, smartphone 20 is capable of automatically generating and uploading status information in the form of an avatar or other visual indicator to a social networking service. Such an uploaded avatar or other indicator is then available to others who receive calls from the user of smartphone 20, or who place calls to the user of smartphone 20, according to the approaches described above relative to FIGS. 4a and 4b, or 5a and 5b, respectively. Alternatively, or in addition to such uploading, the avatar or other indicator can be stored within a memory resource of smartphone 20 (e.g., data memory 25d or non-volatile memory 31), and transmitted as ancillary information by smartphone 20 when placing a phone call, according to the embodiment of the invention described above relative to FIGS. 2a through 2d.

This embodiment of the invention may be implemented by way of program instructions stored within program memory 25p or another memory resource within smartphone 20 of FIG. 1, for example stored within non-volatile memory 31. In the example in which software environment 70 (FIG. 3) is realized within smartphone 20, avatar selection algorithm 82 provides the software functionality that is executable by applications processor 22 to select and generate the avatar or other indicator, based on GPS, accelerometer, calendar, or other inputs from within smartphone 20. In that example, as described above relative to FIG. 3, avatar selection algorithm 82 forwards the selected or generated avatar or other indicator to social networking service widget 74, for uploading to a social networking service to which the user of smartphone 20 subscribes. The avatar or other indicator indicates a current status of the user of smartphone 20, produced automatically by avatar selection algorithm 82 from information already within smartphone 20, without necessarily requiring input or intervention by the user.

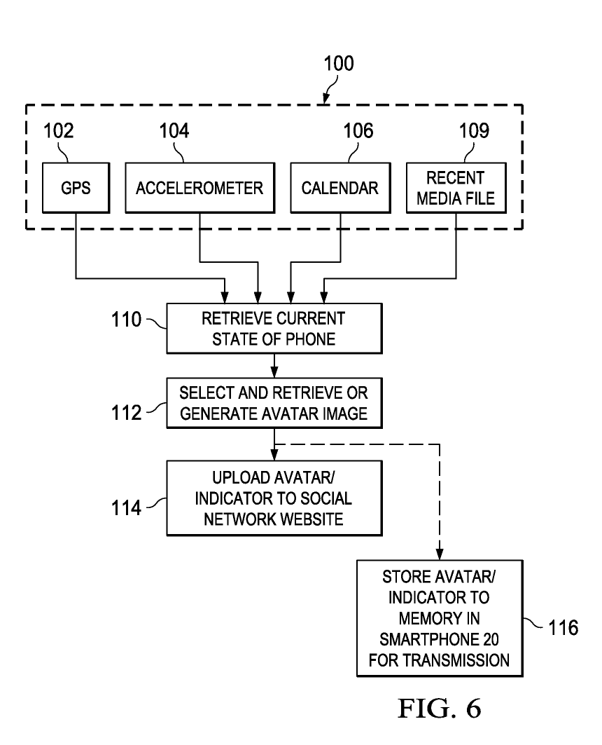

FIG. 6 illustrates the manner in which avatar selection algorithm 82 produces and uploads or stores an avatar or other indicator of the current status of the user of smartphone 20, according to this embodiment of the invention. It is of course contemplated that many variations to this approach will be apparent to those skilled in the art having reference to this specification. As shown in FIG. 6, process 110 within avatar selection algorithm 82 is executed by applications processor 22 to retrieve a current state of smartphone 20 from various input sources 100. Examples of these input sources 100 illustrated in FIG. 6 (and in FIG. 3, for that matter) include GPS function 102, accelerometer 104, and calendar function 106.

As known in the art, Global Positioning System (GPS) capability is now also provided by some conventional smartphones, by way of which those smartphones are capable of deducing their current geographical location by measuring the timing of signals transmitted by GPS satellites, and triangulation of the known locations of the satellites with that message timing, to determine the location of the smartphone itself. Implementation of GPS function 102 within smartphone 20 as indicated in FIG. 6 for this embodiment of the invention, for example by way of GPS receiver 33 in FIG. 1, allows smartphone 20 to calculate its current geographical location. In this realization, GPS function 102 can also query map services (e.g., via Internet access using 3G/4G modem 30) to obtain a description of the current location of smartphone 20. For example, GPS function 102 can determine, in this manner, whether smartphone 20 (and thus its user) is currently located at the user's workplace, the user's home, or another location such as a beach or golf course. Other location-detection sources or computations can alternatively be used; for example, some smartphones can calculate an approximate current position by triangulation from nearby cellular towers, from which a description of the current location can then be obtained as described above. In any case, a descriptive input of the user's current location can be retrieved by avatar selection algorithm 82 as an input, in process 110 of FIG. 6.

Accelerometer source 104 is realized as a built-in accelerometer. Some conventional smartphones, such as the IPHONE mobile telephone handset available from Apple, Inc., include accelerometers by way of which their displays can be oriented in landscape or portrait mode by the user rotating the handset, or by way of which other functions such as the playing of games or the shuffling of stored music can be accomplished by the user. According to this embodiment of the invention, accelerometer source 104 can provide inputs to avatar selection algorithm 82 regarding recent physical motion of smartphone 20, particularly in combination with other inputs such as the current date and time, and perhaps the geographical location indicated by GPS source 102.

Calendar source 106, from which avatar selection algorithm 82 receives inputs in process 110, can be realized by a conventional software function, for example within mobile phone client application 72 in software environment 70, by way of which the user can maintain a schedule of activities such as meetings, appointments, activities, and the like. According to this embodiment of the invention, inputs indicating a currently scheduled activity can be received by avatar selection algorithm 82 from calendar source 106, and used in automatically determining a current status of the user of smartphone 20.

Alternatively or in addition, as shown in FIG. 6, another input source 100 within smartphone 20 may constitute recent media file 109 that is captured, rendered, or otherwise generated or accessed by the user of smartphone 20 and stored in non-volatile memory 31 or another memory resource. According to one example, process 110 may simply retrieve the most recent media file captured or rendered by the user, as that most recent media file can reflect recent activity or status of the user. This allows the user to easily update their status simply by capturing a digital photo of their current location (e.g., office desk, beach, golf course, home). Other examples of content within recent media file 109 can include a recent screen capture from an application being executed by smartphone 20, such as a window in a web browser, presentation application, spreadsheet, or word processing document, or perhaps an error message generated by smartphone 20. Another example of content within recent media file 109 can simply be a capture of the current mobile desktop displayed on smartphone 20. Audio information may also be included within recent media file 109, for example a sample or “snip” of the most recent .mp3 file listened to by the user of smartphone 20. In any case, it is contemplated that smartphone 20 may provide some sort of locked or private status of captured or rendered media files, so that the user can prevent the automatic updating of user status for a recent media file, if desired.

Based on the inputs retrieved by avatar selection algorithm 82 in process 110, avatar selection algorithm 82 next executes process 112 to produce an avatar image corresponding to those inputs. It is contemplated that process 112 can be carried out in various ways. For example, process 112 may simply select an avatar or image from a set of images stored in non-volatile memory 31 based on the current activity, location, time of day, detected motion of smartphone 20, or some combination thereof. More complex approaches to process 112 can include the overlaying of multiple photos, colors, text, images, and the like, with individual ones of those elements corresponding to one or more of the inputs retrieved in process 110. For example, avatar selection algorithm 82 may query a set of rules to determine the appropriate avatar based on the current location of the user based on inputs from GPS source 102, accelerometer source 104, or calendar function 106. For example, the combination of GPS source 102 indicating that the user is on a golf course with calendar function 106 indicating a round of golf at the current time can provoke selection of a golf-related avatar by function 82. Similarly, if calendar function 104 indicates the user is scheduled for a client meeting, avatar selection algorithm 82 may select one of a set of pre-stored avatars within smartphone 20 (or stored in association with the user at the social networking service) indicating the current status of the user as in such a meeting or other work-related function. Alternatively, the user may establish a set of calendar-based rules by way of which the avatar may be selected—for example, Monday through Friday from between 9:00 am and 5:30 pm may correspond to “work” time, such that avatar selection algorithm 82 will select an appropriate avatar during those times. According to another example, if the current date and time is late at night, and if accelerometer source 104 has not detected motion over a long period of time, a rule or set of rules can provoke avatar selection algorithm 82 to select, in process 110, an avatar indicating that the user is sleeping. According to another example, avatar selection algorithm 82 may simply choose recent media file 109 acquired in process 110, and apply that image as the current avatar without any modification except for formatting. As mentioned above, the avatar or other indicator may also include an audio snip, for example as sampled from the most recent .mp3 audio file listened to by the user. It is also contemplated that avatar selection algorithm 82 may also be capable of animating the various images selected in process 112, to provide an avatar or other indicator that has additional expressive impact.

In process 114, avatar selection algorithm 82 issues a request to widget 74, which requests server 75, of a social networking service to which the user of smartphone 20 has subscribed, to upload the avatar or other indicator produced in process 112. It is contemplated that one or more user settings are available within smartphone 20, by way of which the user can identify one or more social networking services along with the corresponding subscriber and log-in information, so that widget 74 is capable of accessing and modifying the current status of the subscriber pages within those social networking services as it executes process 114. The operation of this embodiment of the invention is optimized to the extent that uploading process 114 can be performed without requiring intervention or actions on the part of the user of smartphone 20. In that manner, other parties can automatically retrieve this generated avatar or other status indicator upon receiving a call from the user of smartphone 20, or upon placing a call to the user of smartphone 20, according to the methods described above.

Alternatively, or in addition, to uploading process 114, smartphone 20 may store the avatar or indicator produced in process 112 to a location within one of its memory resources, such as data memory 25d or non-volatile memory 31. In this example, the use of data memory 25d, even if realized by volatile memory, is suitable for this status avatar or other indicator, because such an indicator is intended to be indicative of the current status of the user, and as such the long-term non-volatile storage of such an indicator is of little use. It may be useful to store the avatar or indicator within smartphone 20, in process 116, even if uploading process 114 is executed, in the event that the social networking service is temporarily unavailable or inaccessible to smartphone 20 at the time that process 112 is completed. In addition, if smartphone 20 is configured to transmit ancillary information to an intended recipient of a voice phone call, as described above relative to FIGS. 2a through 2d, storing process 116 will allow the avatar or other indicator generated in process 112 to be available for transmission in connection with or in advance of the placing of a call, allowing all or part of the processes involved in selecting and enabling various contextual and other ancillary information to be omitted.

According to this embodiment of the invention, as described in connection with FIG. 6, smartphone 20 has the capability of generating an accurate status condition for its user, and a visual indicator such as an avatar reflective of that status, without requiring intervention or action on the part of the user. This embodiment thus not only facilitates the availability and use of information ancillary to a phone call, but ensures that the ancillary information is accurate and reflective of the current status and state of the user. The quality and availability of that information is thus greatly improved.

In addition, it is contemplated that this embodiment of the invention described above in connection with FIG. 6 may also be made capable of generating and uploading that status condition to the social networking service at times after a call has already commenced. It is contemplated that this in-call status updating will be especially useful if the visual indicator uploaded to the social networking service is based on a recent screen capture image from smartphone 20; in that event, the parties to a call can effectively participate in a “netmeeting” in which multi-media content (e.g., visual and audible) is communicated within the call.

It is contemplated that other variations to one or more of these embodiments of the invention may be included or implemented, and will be apparent to those skilled in the art having reference to this specification. For example, it is contemplated that emotional profiles of a smartphone user may be associated with groups of contacts, rather than necessarily with individual contacts. In this regard, professional or workplace contacts may receive ancillary information of one type or reflective of only a certain subset of emotional states, while personal contacts would receive ancillary information of a wide range of emotional states. Conversely, rules may be implemented so that certain emotional states or phone call purposes, or the like, do not link to and cannot be made visible to certain groups. It is contemplated that these and other variations and alternatives to the embodiments of the invention described herein will be apparent to those skilled in the art having reference to this specification.

While this invention has been described according to its embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

What is claimed is:

1. A telephone handset system, comprising:
a programmable processor for executing program instructions;
an input peripheral device, coupled to the processor, for receiving user inputs;
a display, coupled to the processor; and
at least one memory resource, coupled to the central processing unit, and comprising program memory for storing program instructions that, when executed by the processor, cause the telephone handset system to perform a plurality of operations for placing a telephone call, the plurality of operations comprising:
receiving, from the input peripheral device, a user input selecting a recipient of the telephone call;
receiving, from the input peripheral device, a user input indicating a first attribute of ancillary information regarding the caller; and
transmitting signals corresponding to a telephone call to the selected recipient, the transmitted signals comprising signals corresponding to voice information and the first attribute of ancillary information.

2. The system of claim 1, further comprising:
a first antenna;
an RF module coupled to the first antenna and to the processor, for transmitting the signals corresponding to voice information responsive to program instructions executed by the processor.

3. The system of claim 1, wherein the plurality of operations further comprises:
displaying a plurality of emotional states on the display; and
receiving, from the input peripheral device, a user input selecting one of the plurality of emotional states, the first attribute of ancillary information regarding the caller corresponding to the selected emotional state.

4. The system of claim 3, wherein the plurality of operations further comprises:
retrieving, from the at least one memory resource, a visual indicator corresponding to the selected emotional state;
wherein the transmitted signals corresponding to the first attribute of ancillary information include signals corresponding to the retrieved visual indicator.

5. The system of claim 3, wherein the plurality of operations further comprises:
receiving, from the input peripheral device, an input indicating a second attribute of ancillary information regarding the caller;
and wherein the transmitted signals further comprise signals corresponding to the second attribute of ancillary information.

6. The system of claim 5, wherein the plurality of operations further comprises:
displaying a plurality of urgency levels on the display; and
receiving, from the input peripheral device, a user input selecting one of the plurality of urgency levels for the call, the second attribute of ancillary information corresponding to the selected urgency level.

7. The system of claim 5, wherein the plurality of operations further comprises:
displaying a plurality of call purposes on the display; and
receiving, from the input peripheral device, a user input selecting one of the plurality of call purposes for the call, the second attribute of ancillary information corresponding to the selected call purpose.

8. The system of claim 1, wherein the plurality of operations further comprises:
retrieving, from the at least one memory resource, a most recent image stored in the at least one memory resource;
wherein the transmitted signals corresponding to the first attribute of ancillary information include signals corresponding to the retrieved most recent image.

9. The system of claim 8, wherein the most recent image corresponds to a screen capture image from the display.

10. The system of claim 1, wherein the plurality of operations further comprises:
retrieving, from the at least one memory resource, a portion of a most recently played audio file stored in the at least one memory resource;
wherein the transmitted signals corresponding to the first attribute of ancillary information include signals corresponding to the retrieved portion of the most recently played audio file.

11. The system of claim 1, wherein the plurality of operations further comprises:
after the telephone call has been accepted by the selected recipient, retrieving, from the at least one memory resource, a screen capture image from the display; and
transmitting signals to the selected recipient, the transmitted signals comprising signals corresponding to the screen capture image.

12. A telephone handset system, comprising:
a programmable processor for executing program instructions;
an input peripheral device, coupled to the processor, for receiving user inputs;
a display, coupled to the processor; and
at least one memory resource, coupled to the central processing unit, and comprising program memory for storing program instructions that, when executed by the processor, cause the telephone handset system to perform a plurality of operations for engaging in a telephone call, the plurality of operations comprising:
responsive to initiation of the telephone call with a party, identifying one of a plurality of contacts stored in the at least one memory resource as corresponding to the party;
transmitting a query to an online social networking service with an identifier corresponding to the identified contact;
receiving signals from the online social networking service in response to the query regarding the identified contact;
displaying a visual indicator, on the display, corresponding to the received signals from the online social networking service; and
transmitting and receiving signals corresponding to voice information in the telephone call with the party.

13. The system of claim 12, further comprising:
a first antenna;
an RF module coupled to the first antenna and to the processor, for transmitting the signals corresponding to voice information responsive to program instructions executed by the processor.

14. The system of claim 12, wherein the plurality of operations further comprises:
generating the visual indicator responsive to content in the received signals from the online social networking service.

15. The system of claim 12, wherein the party corresponds to a calling party;
wherein the identifying operation is performed responsive to receiving an incoming telephone call from the calling party;
wherein the plurality of operations further comprises:
after the displaying step, receiving, from the input peripheral device, a user input indicating that the call is to be accepted;
and wherein the transmitting and receiving operation is performed responsive to receiving the user input indicating that the call is to be accepted.

16. The system of claim 15, wherein the plurality of operations further comprises:
after the displaying step, receiving, from the input peripheral device, a user input indicating that the call is to not be accepted;
wherein the transmitting and receiving operation is not performed responsive to receiving the user input indicating that the call is to not be accepted.

17. The system of claim 12, wherein the party corresponds to an intended recipient of a telephone call being placed by the system;
wherein the identifying operation comprises:
receiving, from the input peripheral device, a user input selecting the intended recipient of the telephone call;
wherein the plurality of operations further comprises:
after the displaying step, receiving, from the input peripheral device, a user input indicating that the call is to be placed;
and wherein the transmitting and receiving operation is performed responsive to receiving the user input indicating that the call is to be placed.

18. The system of claim 12, further comprising:
one or more input sources coupled to the processor for determining a current state of the system;
and wherein the plurality of operations further comprises:
retrieving a current state from at least one of the one or more input sources;
generating a visual indicator responsive to the current state of the system.

19. The system of claim 18, wherein the plurality of operations further comprises:
uploading the generated visual indicator to an online social networking service.

20. The system of claim 18, wherein the plurality of operations further comprises:
storing the generated visual indicator in the at least one memory resource;
receiving, from the input peripheral device, a user input selecting a recipient of the telephone call; and
transmitting signals corresponding to a telephone call to the selected recipient, the transmitted signals comprising signals corresponding to voice information and to the generated visual indicator.

21. The system of claim 18, wherein the one or more input sources is selected from a group consisting of a function that determines a geographic location of the system, an accelerometer, a calendar function, an image that was recently stored in the at least one memory resource, a screen capture image from the display, and at least a portion of a recently-played audio file stored in the at least one memory resource.

22. A method of operating a telephone handset to place a telephone call, comprising the steps of:
selecting a recipient of the telephone call;
inputting, into the telephone handset, a first attribute of ancillary information regarding the caller; and
transmitting signals corresponding to a telephone call to the selected recipient, the transmitted signals comprising signals corresponding to voice information and the first attribute of ancillary information.

23. The method of claim 22, wherein the step of inputting the first attribute of ancillary information regarding the caller comprises:
displaying a plurality of emotional states on a display of the telephone handset; and
selecting one of the plurality of emotional states, the first attribute of ancillary information regarding the caller corresponding to the selected emotional state.

24. The method of claim 23, further comprising:
retrieving, from a memory resource in the telephone handset, a visual indicator corresponding to the selected emotional state;
wherein the transmitted signals corresponding to the first attribute of ancillary information include signals corresponding to the retrieved visual indicator.

25. The method of claim 23, further comprising:
inputting, into the telephone handset, a second attribute of ancillary information regarding the caller;
and wherein the transmitted signals further comprise signals corresponding to the second attribute of ancillary information.

26. The method of claim 25, wherein the step of inputting the second attribute of ancillary information regarding the caller comprises:
displaying a plurality of urgency levels on the display; and
selecting one of the plurality of urgency levels for the call, the second attribute of ancillary information corresponding to the selected urgency level.

27. The method of claim 25, wherein the step of inputting the second attribute of ancillary information regarding the caller comprises:
displaying a plurality of call purposes on the display; and
selecting one of the plurality of call purposes for the call, the second attribute of ancillary information corresponding to the selected call purpose.

28. The method of claim 22, wherein the plurality of operations further comprises:
retrieving, from a memory resource in the telephone handset, a most recent image stored in the at least one memory resource;
wherein the transmitted signals corresponding to the first attribute of ancillary information include signals corresponding to the retrieved most recent image.

29. The method of claim 28, wherein the most recent image corresponds to a screen capture from the display of the telephone handset.

30. The method of claim 22, wherein the plurality of operations further comprises:
retrieving, from a memory resource in the telephone handset, a portion of a most recently played audio file stored in the at least one memory resource;
wherein the transmitted signals corresponding to the first attribute of ancillary information include signals corresponding to the retrieved portion of the most recently played audio file.

31. The method of claim 22, wherein the plurality of operations further comprises:
after the telephone call has been accepted by the selected recipient, retrieving, from the at least one memory resource, a screen capture image from the display; and
transmitting signals to the selected recipient, the transmitted signals comprising signals corresponding to the screen capture image.

32. A method of engaging in a telephone call with a party using a telephone handset, comprising:
identifying one of a plurality of contacts stored in a memory resource as corresponding to the party of the telephone call;
transmitting a query to an online social networking service with an identifier corresponding to the identified contact;
receiving signals from the online social networking service in response to the query regarding the identified contact;
displaying a visual indicator, on a display of the telephone handset, the visual indicator corresponding to the received signals from the online social networking service; and
transmitting and receiving signals corresponding to voice information in the telephone call with the party.

33. The method of claim 32, wherein the party corresponds to a calling party;
wherein the method further comprises:
receiving an incoming telephone call from the calling party, so that the identifying step is performed responsive to information in the incoming telephone call corresponding to the calling party; and
after the displaying step, receiving, from an input peripheral device of the telephone handset, a user input indicating whether the call is to be accepted;
wherein the transmitting and receiving step is performed responsive to receiving a user input indicating that the call is to be accepted;
and wherein the transmitting and receiving operation is not performed responsive to receiving the user input indicating that the call is to not be accepted.

34. The method of claim 32, wherein the party corresponds to an intended recipient of a telephone call being placed by the telephone handset;
wherein the identifying step comprises:
displaying, on the display of the telephone handset, the plurality of contacts;
selecting the intended recipient of the telephone call from the displayed plurality of contacts;
wherein the method further comprises:
after the step of displaying the visual indicator, receiving, from the input peripheral device, a user input indicating whether the call is to be placed;
and wherein the transmitting and receiving operation is performed responsive to receiving a user input indicating that the call is to be placed.

35. The method of claim 32, further comprising:
generating the visual indicator responsive to content in the received signals from the online social networking service.

36. The method of claim 32, further comprising:
retrieving a current state of the telephone handset from at least one of one or more input sources in the telephone handset;
generating a visual indicator responsive to the current state of the system.

37. The method of claim 36, wherein the one or more input sources is selected from a group consisting of a function that determines a geographic location of the system, an accelerometer, a calendar function, an image that was recently stored in a memory resource in the telephone handset, a screen capture image from the display, and at least a portion of a recently-played audio file stored in the at least one memory resource.

38. The method of claim 36, further comprising:
uploading the generated visual indicator to an online social networking service.

39. The method of claim 36, further comprising:
storing the generated visual indicator in the at least one memory resource;
displaying, on the display of the telephone handset, the plurality of contacts;
selecting a recipient of the telephone call from the displayed plurality of contacts; and
transmitting signals corresponding to a telephone call to the selected recipient, the transmitted signals comprising signals corresponding to voice information and to the generated visual indicator.
